(19) United States
(12) Patent Application Publication
(10) Pub. No.: US 2010/0014467 A1
(43) Pub. Date: Jan. 21, 2010

(54) OPERATING METHOD OF A USER TERMINAL SUPPORTING HIGH SPEED DOWNLINK PACKET ACCESS

(76) Inventors: Darun Wang, Qingpu District (CN); Jinling Hu, Qingpu District (CN)

Correspondence Address: FULBRIGHT & JAWORSKI L.L.P, 2200 ROSS AVENUE, SUITE 2800, DALLAS, TX, 75201-2784, US

(21) Appl. No.: 11/993,797

(22) PCT Filed: Jun. 8, 2006
(86) PCT No.: PCT/CN2006/001257

§ 371 Date: Sep. 25, 2009

(30) Foreign Application Priority Data
Jun. 28, 2005 (CN) 200510080201.8

(51) Int. Cl. H04W 72/04

(52) U.S. Cl. 370/329

(57) ABSTRACT

An operating method of a user equipment supporting HSDPA, comprising: a user equipment sending a message carrying information indicating the user terminal's access capability; the user equipment receives data on carriers allocated by RAN. The present invention enables RAN to learn the user equipment's capability for receiving carriers and to allocate radio resource to the user equipment according to the learning, thereby realizing the user equipment operating smoothly with RAN.

### FIELD OF THE INVENTION

The present invention relates to the technical field of radio communication, particularly to an operating method of user equipment (UE) for high speed downlink packet access (HSDPA) service.

### BACKGROUND OF THE INVENTION

In order to support high speed downlink data services, the 3GPP (3rd Generation Partnership Project) Specification Release 5 has put forward High Speed Downlink Packet Access (HSDPA) service, in which all the subscribers share the code channel resources. The specification has also defined key techniques of HSDPA in details, such as Adaptive Modulation Coding (AMC), Hybrid Automatic Repeat Request (HARQ), etc. In HSDPA, the modulation and coding scheme will be changed as the quality of the radio link varies. Link-Adaptive modulation will ensure that the subscriber may obtain a transmission rate as high as possible, no matter whether the subscriber is in the vicinity of the base station or on the border of a cell. The new modulation code in HSDPA will greatly improve the data transmission rate and throughput for the subscribers and improve frequency band utilization rate. In addition, the subscribers can obtain higher connection data rate.

HARQ is, in nature, a combination of Forward Error Code (FEC) and Automatic Repeat Request (ARQ). FEC can improve transmission reliability; however, if the channel condition is good, too many error correction bits will degrade the throughput. ARQ can achieve ideal throughput if the error rate is not high; however, it will cause delay. FEC and ARQ are combined to form HARQ. Each data packet to be sent contains bits for error correction and error detection. If the number of error bits in a received packet is not beyond the capability for error correction, the error will be corrected automatically; if the error is severe and beyond the error correction capability of FEC, the transmitter will be notified to resend the packet. With AMC and HARQ techniques, UEs with good channel condition can be scheduled with higher data rates, while UEs with poor channel condition can be scheduled with lower data rates.

FIG. 1 is a schematic diagram of a part of the architecture of a cell of WCDMA or TD-SCDMA system. As shown in FIG. 1, the TD-SCDMA system comprises a radio network controller (RNC), a Node B and User Equipments (UEs). In a cell of the TD-SCDMA system, the resources related to HSDPA include High Speed-Physical Downlink Shared Channel (HS-PDSCH) designed to transmit service data, High Speed-Shared Control Channel (HS-SCCH) designed to transmit signaling information, and High Speed-Shared Information Channel (HS-SICH) designed to transmit the control information returned from the UEs.

In a cell, relevant HSDPA resources are configured/reconfigured for the cell by RNC through a physical shared channel reconfiguration process. The transmission channel that is used to carry higher layer data is the High Speed-Downlink Shared Channel (HS-DSCH), the data in HS-DSCH is coded, interleaved, and then mapped to the HS-PDSCH to be transmitted, and the UE interacts with the radio access network through the High Speed-Shared Control Channel (HS-SCCH) and High Speed-Shared Information Channel (HS-SICH). The UE receives and processes the data through HS-PDSCH in accordance with the control information in HS-SCCH, and responds the radio access network with ACK/NACK and Channel Quality Indicator (CQI) through HS-SICH in accordance with the decoding result for the received data and the channel measurement result; the radio access network will control the transmission of the subsequent data to the UE in accordance with the response.

In view of the fact that the data rate provided by single carrier is limited, in order to improve the available data rate of the system usually multiple carriers are used for data transmission by means of extending carrier frequency.

In the prior art, if a UE that only supports single carrier works in a multi-carrier cell, the radio access network may send data simultaneously on multiple carriers because the radio access network doesn't know whether the UE is capable of receiving multiple carriers. As the result, the UE may not work normally.

### SUMMARY OF THE INVENTION

One object of the present invention is to provide an operating method of user equipment (UE) for high speed downlink packet access (HSDPA) service, to enable the radio access network to learn whether the UE has multi-carrier data receiving capability and then allocate radio resources in accordance with the UE's receiving capability.

The operating method of UE for HSDPA service according to the present invention comprises:

sending, by the UE, a message that carries information indicating the UE's radio access capability to a radio access network;

allocating, by the radio access network, carrier resources for the UE in accordance with the information indicating the UE's radio access capability; and

transmitting, by the UE, data on the carriers allocated by the radio access network.

Preferably, said method further comprises:

adding an information element indicating the UE's radio access capability in an interface message sent from the UE;

including, in the information element indicating the UE's radio access capability, the number of carriers that can be received by the UE simultaneously.

Said interface message comprises a RRC (Radio Resource Control) Connection Setup Complete message and/or a UE Capability Information message. During the process of setting up RRC connection, the UE reports its radio access capability to the radio network controller in the RRC Connection Setup Complete message.

Said interface message further comprises RRC Connection Setup Request message; an information element is added in the RRC Connection Setup Request message to indicate the UE's carrier-receiving capability.

The radio network controller of the radio access network learns from the message sent from the UE the number of carriers that can be received by the UE simultaneously.

Preferably, said method further comprises:

when allocating radio resources to the UE, notifying the base station, by the radio network controller, of the number of carriers that can be received by said UE simultaneously; and

allocating, by the base station, carrier resources to the UE in accordance with the number of carriers that can be received by the UE simultaneously.

The interface message sent from a subscriber comprises HS-DSCH TDD (Time Division Duplex) information;

An information element indicating the number of carriers that can be received by the UE simultaneously is added in the HS-DSCH TDD information.

The interface message comprises a Radio Link Setup Request message or a Radio Link Reconfiguration Prepare message, which includes an information element indicating the number of carriers that can be received by the UE simultaneously.

In the present invention, by adding an indication of the number of carriers that can be received by the UE simultaneously in the air interface message and the interface message between the network entities in the radio access network, the radio access network can accurately learn about the UE's carrier-receiving capability, and thereby allocate radio resources for the UE. Therefore, in a multi-carrier cell, the system can provide service to UEs with different frequency receiving capabilities simultaneously and realizes coordination between UEs and the radio access network. As a result, the present invention can take full advantage of the radio resources and improve system efficiency.

### BRIEF DESCRIPTION OF THE DRAWINGS

FIG. 1 is a schematic diagram of a part of the architecture of a cell of WCDMA or TD-SCDMA system;

FIG. 2 is a flow diagram of a method according to an embodiment of the present invention.

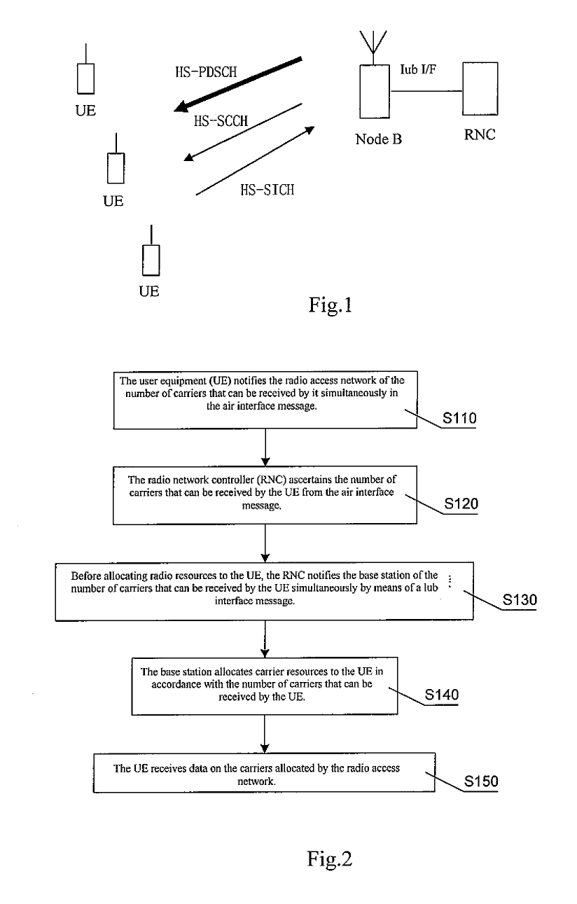

### DETAILED DESCRIPTION OF THE EMBODIMENTS

In the current 3GPP Release 5 specification, HSDPA employs single-carrier transmission, i.e., the subscriber receives the service channel data on a single carrier. Due to the limitation on signal bandwidth, with HSDPA technique, the peak data transmission rate is affected. If HSDPA technique is used in combination with multi-carrier technique, the data transmission rate can be further improved.

In order to provide service to UEs with different carrier-receiving capabilities in a multi-carrier cell, a mechanism is required to enable the radio access network to allocate carriers to a UE in accordance with the carrier-receiving capability of the UE.

In a Time Division Synchronous Code Division Multiple Access (TD-SCDMA) system, for example, when a UE is to start a data transmission process, the procedures from connection start to resource allocation will be as follows:

Perform a process of setting up Radio Resource Control (RRC), to set up a signaling connection between the UE and the Radio Network Controller (RNC) of the radio access network. In the process, the UE will report its radio access capability to the RNC;

Perform a process of setting up Non Access Stratum (NAS), to set up a signaling connection between the UE and the Core Network (CN). In the process, the UE will submit a request for radio resources;

Perform a process of setting up Radio Access Bearer (RAB), to set up a user plane bearer for transmission of voice, data and multimedia services between the UE and the CN. The process comprises allocating by the radio access network to the UE radio resources to be occupied by the UE.

Above processes will be performed by means of message interaction between the UE, the base station (Node B), the RNC, and the CN. The messages carry a variety of information elements (IEs). The information elements have contents and formats complying with the specification, and are used to transmit various parameters and other information required for setting up connections between message senders and message receivers. If different messages in different processes are to transmit identical parameters and information, they will include identical information elements.

In the RRC setup process, the UE can report its radio access capability to the radio network controller in the RRC Connection Setup Complete message, the message transmitting the UE's radio access capability information by means of the information element comprised in the message and indicating the UE's radio access capability. In addition, the information element indicating the UE's radio access capability is also used in other air interface messages necessary to transmit the information, such as in the UE Capability Information message sent from the UE to the RNC. The UE Capability Information message is used as a response to the UE capability query message sent from the RNC to the UE.

In the RAB setup process, the radio access network will allocate radio resources to the UE. For a multi-carrier cell, since HSDPA employs a shared channel model, it is possible that the RNC will allocate the same shared channel to a group of UEs that may have different capabilities, and the shared channel may be across a plurality of carriers, and the base station schedules data transmissions to each UE in the range of the plurality of carriers. The RNC notifies the base station of a UE's capability information by means of a Radio Link Setup Request message or Radio Link Reconfiguration Prepare message, the capability information being included in the HS-DSCH TDD Information. Likewise, the information is also used in other Iub interface messages.

If an indication of the number of carriers that can be received by the UE simultaneously is added in the information element indicating UE radio access capability, the UE can notify the RNC of its carrier-receiving capability through an air interface message. Similarly, an indication of the number of carriers that can be received by the UE can also be included in any other information element in the air interface message or a user-defined information element used in the air interface message, so that the radio access network can ascertain the UE's carrier-receiving capability. For example, an information element can be added into the RRC Connection Setup Request message to indicate the UE's carrier-receiving capability.

Likewise, if an indication of the number of carriers that can be received by the UE simultaneously is added into the HS-DSCH TDD information element, the base station can learn about the UE's carrier-receiving capability from the RNC before allocating radio resources. Similarly, an indication of the number of carriers that can be received by the UE simultaneously can also be included in any other information element in the Iub interface message or a user-defined information element used in the Iub interface message, so that the base station can ascertain the UE's carrier-receiving capability before allocating radio resources for the UE.

FIG. 2 is a flow diagram of a method according to an embodiment of the present invention. See FIG. 2 for the operating method of the HSDPA UE in a multi-carrier cell.

In step S110, the UE notifies, though an air interface message, the radio access network of the number of carriers it can receive simultaneously. As described above, an indication of the number of carriers that can be received by the UE simultaneously is added into an information element (e.g., UE radio access capability) in the air interface message. Then, the UE can notify the RNC in the radio access network of its carrier-receiving capability by means of the air interface message containing the information element.

In step S120, the RNC ascertains from the air interface message the number of carriers that can be received by the UE simultaneously.

In step S130, when allocating radio resources to the UE, the RNC notifies, through an Iub interface message, the base station of the number of carriers that can be received by the UE simultaneously. As described above, an indication of the number of carriers that can be received by the UE simultaneously is added into an information element (e.g., HS-DSCH TDD Information) in the Iub interface message, so that the RNC can notify the base station of the UE's carrier receive capability by means of the Iub interface message containing the information element.

In step S140, the base station allocates carrier resources to the UE in accordance with the number of carriers that can be received by the UE simultaneously.

In step S130 and block S140, the radio access network allocates carrier resources to the UE in accordance with the number of carriers that can be received by the UE simultaneously. In that way, the radio access network can allocate carrier resources to the NE within the limit of the number of carriers supported by the UE, so as to avoid the case that the data can't be received normally because the number of carriers exceeds the limit of the UE's carrier-receiving capability.

In step S150, the UE transmits data on the carriers allocated by the radio access network. The UE can receive the data in the HSDPA shared channel on the carriers allocated to the UE, and can send uplink feedback data on the carriers.

For example, suppose an indication of the number of carriers that can be received simultaneously by a UE is added into an information element “UE radio access capability”, a possible implementation is shown in Table 1, which is in the standard format defined in 3GPP specification T25331. Except for the third item, all the items in Table 1 are provided with standard definitions in 3GPP and will not be described further here.

TABLE 1

| Information | | | | | |
|---|---|---|---|---|---|
| Element/Group | | | Type and | | |
| name | Need | Multi | reference | Semantics description | Version |
| Access | MP | | Enumerated | As specified in | |
| stratum | | | (R99) | Reference Document | |
| release | | | | [35], it indicates the | |
| indicator | | | | Release No. of the UE. | |
| | | | | This information | |
| | | | | element also indicates | |
| | | | | the RRC layer | |
| | | | | transmission syntax | |
| | | | | supported by the UE. | |
| | CV-not_rrc_connectionSetupComplete | | Enumerated | 15 values are reserved | REL-4 |
| | | | (REL-4) | | |
| UE specific | CV-not_rrc_connectionSetupComplete | | Enumerated | This information | REL-4 |
| requirement | | | (REL-4-multicarrier) | element indicates some | |
| indicator | | | | special requirements of | |
| | | | | the UE, and 3 values | |
| | | | | are reserved. | |
| Number of | O | | Maximum | This information | |
| carrier | | | number of | element indicates the | |
| | | | carrier that UE | maximum number of | |
| | | | can receive data | carriers that can be | |
| | | | simultaneously. | received by the UE. | |
| | | | x.x.x.x | | |
| PDCP | MP | | PDCP capability | | |
| capability | | | 10.3.3.24 | | |
| RLC | MP | | RLC capability | | |
| capability | | | 10.3.3.34 | | |
| Transport | MP | | Transport | | |
| channel | | | channel | | |
| capability | | | capability | | |
| | | | 10.3.3.40 | | |
| RF capability | OP | | RF capability | | |
| FDD | | | FDD 10.3.3.33 | | |
| RF capability | OP | 1 to 2 | RF capability | Each system with a | REL-4 |
| TDD | | | TDD 10.3.3.33b | different chip rate | |
| | | | | comprises a “TDD RF | |
| | | | | capability” information | |
| | | | | element. | |
| Physical | MP | | Physical | | |
| channel | | | channel | | |
| capability | | | capability | | |
| | | | 10.3.3.25 | | |
| UE | MP | | UE | | |
| multi-mode/ | | | multi-mode/ | | |
| multi-RAT | | | multi-RAT | | |
| capability | | | capability | | |
| | | | 10.3.3.41 | | |
| Security | MP | | Security | | |
| capability | | | capability | | |
| | | | 10.3.3.37 | | |
| UE | MP | | UE positioning | | |
| positioning | | | capability | | |
| capability | | | 10.3.3.45 | | |
| Measurement | CH-fdd_req_sup | | Measurement | | |
| capability | | | capability | | |
| | | | 10.3.3.21 | | |

The third item in Table 1 is newly added according to the present invention, with name of “Number of Carriers”, with the column “Need” indicating this item is an optional one, the column “Multi” indicating this item can appear multiple times, the column “Type and reference” indicating the position of the detailed explanation of the item in the specification, and the column “Semantics description” indicating that this item is used to indicate the number of carriers on which the UE can receive data simultaneously.

With the information unit “UE radio access capability” being modified as above, all air interface messages contain the information element can transmit information about the UE's carrier-receiving capability.

For example, suppose an indication of the number of carriers that can be received simultaneously by a UE is added into the information unit “HS-DSCH TDD Information”, a possible implementation is shown in Table 2, in the standard format defined in 3GPP specification T25331. Except for the fourth item, all the items in Table 2 are provided with standard definitions in 3GPP, and will not be described further here.

TABLE 2

| | | Type and | |
|---|---|---|---|
| IE/Group Name | Presence | Reference | Semantics Description |
| HS-DSCH MAC-d Flows | M | 9.2.1.31IA | |
| Information | | | |
| UE Capabilities Information | | | |
| HS-DSCH Physical Layer | M | 9.2.1.31Ia | |
| Category | | | |
| Number of carrier | O | 9.x.x.x | This information element |
| | | | indicates the maximum number |
| | | | of carriers on which the UE can |
| | | | receive data simultaneously. |
| MAC-hs Reordering Buffer Size | M | 9.2.1.38Ab | |
| for RLC-UM | | | |
| TDD ACK NACK Power Offset | M | 9.2.3.18F | |

The fourth item in Table 2 is newly added according to the present invention, under the name of “Number of Carriers”, with the column “Presence” indicating this item is an optional one, the column “Type and Reference” indicating the position of the detailed explanation of the item in the specification, and the column “Semantics Description” indicating this item is used to indicate the number of carriers on which the UE can receive data simultaneously.

With the information element “HS-DSCH TDD Information” being modified as above, all Iub interface messages containing the information element can transmit information about the UE's carrier-receiving capability.

From above it could be seen that according to the present invention, through adding a capability indication of the number of carriers that can be received by the UE simultaneously into air interface messages and interface messages between network entities, the radio access network is notified of the accurate carrier-receiving capability of the UE, so that resource allocation activities could be coordinated between the network and the UE.

While the present invention has been illustrated and described with reference to some preferred embodiments, the present invention is not limited thereto. Those skilled in the art should recognize that various variations and modifications can be made without departing from the spirit and scope of the present invention as defined by the accompanying claims.

1. An operating method of UE for HSDPA service, comprising:
sending, by the UE, a message that carries information indicating the UE's radio access capability to a radio access network;
allocating, by the radio access network, carrier resources for the UE in accordance with the information indicating the UE's radio access capability; and
receiving, by the UE, data on the carrier allocated by the radio access network.

2. The operating method of UE according to claim 1, further comprising:
adding an information element indicating the UE's radio access capability in an interface message sent from the UE; and
including, in the information element indicating the UE's radio access capability, the number of carriers that can be received by the UE simultaneously.

3. The operating method of UE according to claim 2, wherein said interface message comprises a Radio Resource Control (RRC) Connection Setup Complete message and/or a UE Capability Information message, and during the process of setting up RRC connection, the UE reports its radio access capability to the radio network controller in the RRC Connection Setup Complete Message.

4. The operating method of UE according to claim 2, wherein said interface message further comprises a RRC Connection Setup Request message, in which is added an information element to indicate the UE's carrier-receiving capability.

5. The operating method of UE according to claim 1, wherein the radio network controller of the radio access network learns from the message sent from the UE the number of carriers that can be received by the UE simultaneously.

6. The operating method of UE according to claim 5, further comprising:
when allocating radio resources to the UE, notifying the base station, by the radio network controller, of the number of carriers that can be received by said UE simultaneously; and allocating, by the base station, carrier resources to the UE in accordance with the number of carriers that can be received by the UE simultaneously.

7. The operating method of UE according to claim 5, wherein the interface message sent from RNC to Node B comprises HS-DSCH TDD information; and
an information element indicating the number of carriers that can be received by the UE simultaneously is added in the HS-DSCH TDD information.

8. The operating method of UE according to claim 7, wherein the interface message comprises a Radio Link Setup Request message or a Radio Link Reconfiguration Prepare message, which includes an information element indicating the number of carriers that can be received by the UE simultaneously.
